(19) United States
(12) Patent Application Publication
(10) Pub. No.: US 2022/0282528 A1
(43) Pub. Date: Sep. 8, 2022

(54) VEHICLE LOCK

(71) Applicant: DGL Group Ltd., Edison, NJ (US)

(72) Inventor: Ezra Zaafarani, Brooklyn, NY (US)

(21) Appl. No.: 17/192,274

(22) Filed: Mar. 4, 2021

(51) Int. Cl. E05B 71/00; B62H 5/00

(52) U.S. Cl. CPC E05B 71/00; B62H 5/00; B62H 2005/008

(57) ABSTRACT

A vehicle is provided to include: at least one wheel including an axle axis; and a vehicle lock. The vehicle lock may include: a lock support forming a part of the axle axis; and a detachable handle that is spaced from and is detachable relative to the lock support.

### FIELD

The present disclosure generally relates to a vehicle lock.

### BACKGROUND

Conventionally, vehicles such as a scooter and a bicycle are used. Preventing theft of such vehicles is one of considerations in the art.

The description provided in the background section should not be assumed to be prior art merely because it is mentioned in or associated with the background section. The background section may include information that describes one or more aspects of the subject technology.

### SUMMARY

One embodiment of the present disclosure may provide a vehicle. The vehicle may include: at least one wheel including an axle axis; and a vehicle lock. The vehicle lock may include: a lock support forming a part of the axle axis; and a detachable handle that is spaced from and is detachable relative to the lock support.

Another embodiment of the present disclosure may provide a vehicle lock. The vehicle lock may include: a lock support configured to form a part of an axle axis of a wheel; and a detachable handle that is spaced from and is detachable relative to the lock support.

Another embodiment of the present disclosure may provide a method. The method may include detaching a detachable handle of a vehicle lock from a lock support of the vehicle lock. The lock support forms a part of an axle axis of a wheel. The method may further include attaching the detachable handle to the lock support with a fixed structure being surrounded by the detachable handle and the lock support.

### DRAWINGS

FIG. 1 illustrates a perspective view of a vehicle according to one embodiment.

FIG. 2 illustrates a partial perspective view of a vehicle according to one embodiment.

FIG. 3 illustrates a side view of a vehicle according to one embodiment.

FIG. 4 illustrates a plan view of a vehicle according to one embodiment.

FIG. 5 illustrates a perspective view of a vehicle lock according to one embodiment.

FIG. 6 illustrates a flowchart showing use of a vehicle lock according to one embodiment.

### EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

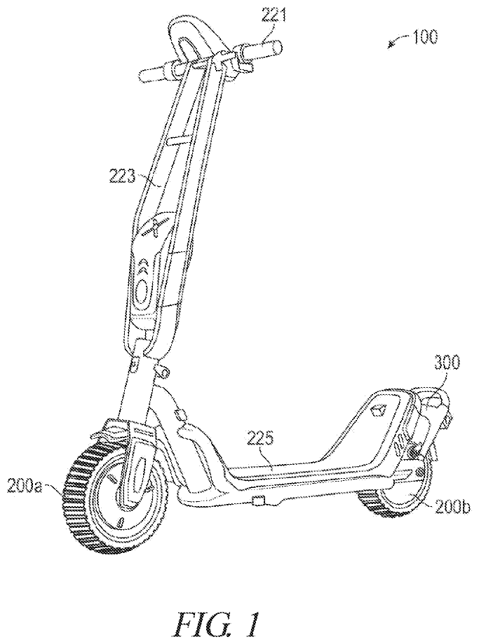

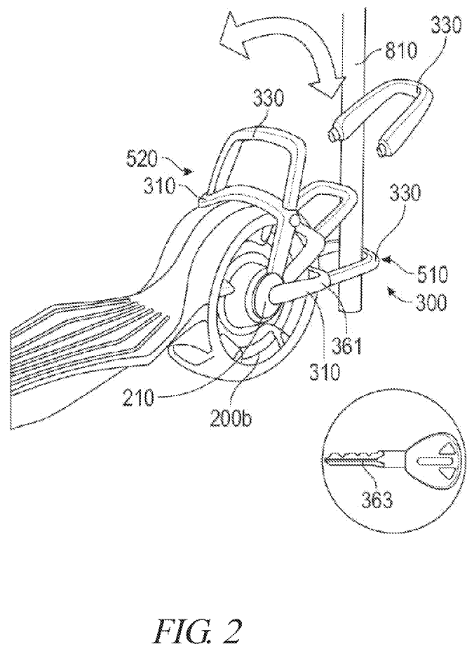

FIG. 1 illustrates a perspective view of a vehicle according to one embodiment. FIG. 2 illustrates a partial perspective view of a vehicle according to one embodiment.

A vehicle according to embodiments may include, but not limited to, electric and non-electric scooters, motorcycles, bicycles, baby carriages, wagons, construction vehicles, and other vehicles. In some embodiments, the vehicle may include a two-wheeled vehicle. In other embodiments, the vehicle may include a vehicle with more than two wheels, such as a three-wheeled vehicle and a four-wheeled vehicle. In the illustrated example of FIG. 1, the vehicle 100 may include at least one wheel. The number of wheels may be any reasonable number, such as 2, 3, and 4, etc. In one embodiment, the vehicle 100 may include front and rear wheels 200a and 200b respectively.

Further, in the illustrated example, the vehicle 100 may include a handlebar 221 mounted on a vertical portion 223 operably coupling the handlebar 221 to the front wheel 200a. Turning of the handlebar 221 by a rider operates to turn the front wheel 200a. Additionally, the vehicle 100 may include a foot platform 225, and the wheels 200a and 200b are disposed below the platform 225.

As shown in FIGS. 2-4, the vehicle 100 may include a vehicle lock 300. The vehicle lock 300 may be provided to any one of the wheels. In the illustrated example, the vehicle lock 300 is provided to the rear wheel 200b, but in another embodiment, the vehicle lock 300 may be provided to the front wheel 200a. The vehicle lock 300 may include a lock support 310 and a detachable handle 330. The lock support 310 may form a part of an axle axis of one of at least one wheels. For example, in one embodiment, the lock support 310 may form a part of an axle axis 210 of the rear wheel 200b. In another embodiment, the lock support 310 may form a part of an axle axis of another wheel, for example, the front wheel 200a in the example of FIG. 1. The detachable handle 330 may be attached to the lock support 310. The detachable handle 330 may be spaced from and be detachable relative to the lock support 310.

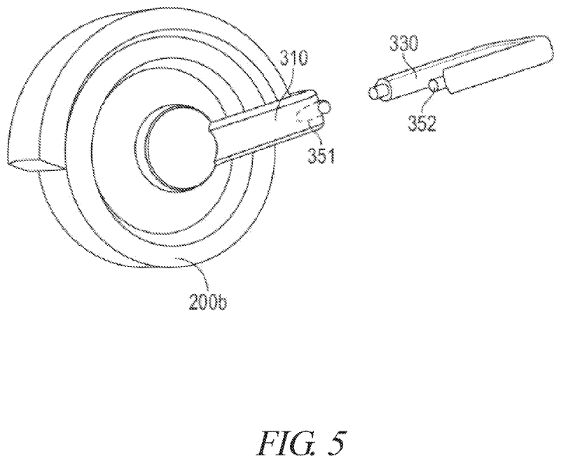

As shown in FIG. 5, in one embodiment, the lock support 310 may include a first engagement portion 351, and the detachable handle 330 may include a second engagement portion 352 that engages with the first engagement portion 351. In one example, one of the first engagement portion 351 and the second engagement portion 352 may be a protrusion, and the other one of the first engagement portion 351 and the second engagement portion 352 may be an insertion hole into which the protrusion may be inserted. In one embodiment, each of the first engagement portion 351 and the second engagement portion 252 may be located at either side of the wheel 200b. Further, optionally, another first engagement portion and another second engagement portion may be located at the other side of the wheel 200b.

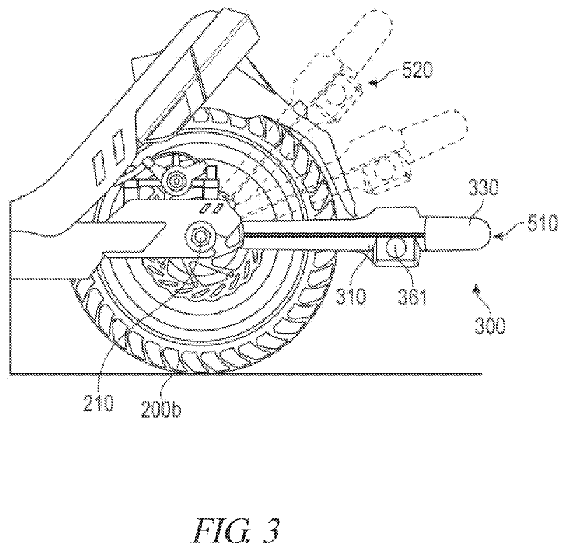

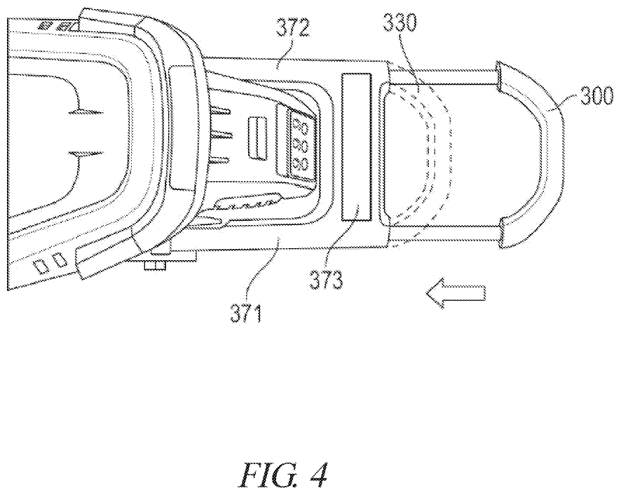

As shown in the illustrated example of FIGS. 2 and 3, one of the lock support 310 and the detachable handle 330 may include a lock element 361 that locks the detachable handle 330 to the lock support 310. A key 363 may be used to lock and unlock the lock element 361. The lock element 361 does not need to be used with the key 363. The lock element may be a multiple-number combination lock element or an electrically operable lock element. As shown in FIG. 4, in one example, the vehicle lock 300 may include a first rod 371, a second rod 372, and a connection 373. The first rod 371 may extend on one side of the wheel 200b and the second rod 372 may extend on the other side of the wheel 200b. The connection 373 may connect the first rod 371 and the second rod 372.

As shown in FIGS. 2 and 3, in one embodiment, the lock support 310 may optionally be pivotable about the axle axis 210 of the wheel 200b, for example, between a first position 510 and a second position 520. The lock support 310 may be in the first position 510 when the vehicle lock 300 may be used to be connected to the fixed structure 810. The lock support 310 may be in the second position 520 when the vehicle 100 is traveling. In some embodiments, the lock support 310 may be positioned and fixed at two or more pivot positions about the axle axis 210. In other embodiments, the lock support 310 may not be pivotable about the axle axis 210 the whole time, and may be fixed horizontally, downward, or upward at a single position the whole time.

As shown in FIG. 2, the vehicle lock 300 may be connected to a fixed structure 810, such as a pole fixed to the ground or to a building, to prevent theft of the vehicle 100.

According to the present embodiments, the vehicle lock may form a part of an axle axis of a wheel. Such a vehicle lock may be unobtrusive and/or easy to use. Further, in some embodiments, the vehicle lock may reduce or avoid the need to carry a separate lock, and/or may reduce or avoid the need to make space on the vehicle to house the vehicle lock. Also, the vehicle lock forming a part of an axle axis of a wheel can make the lock more difficult to detach.

FIG. 6 illustrates a flowchart showing use of a vehicle lock according to one embodiment. With reference to FIG. 6, in 601, when using the vehicle lock 300, after the vehicle 100 stops, the position of the lock support 310 may be changed from the second position 520 to the first position 510. Then, in 603, the detachable handle 330 of the vehicle lock 300 may be detached from the lock support 310 of the vehicle lock 300. Then, in 605, the vehicle lock 300 may be connected with the fixed structure 810 by surrounding the fixed structure 810 with the detachable handle 330 and the lock support 310. Then, in 607, the detachable handle 330 may be attached to the lock support 310 with the fixed structure 810 being surrounded by the detachable handle 330 and the lock support 310. To unlock the vehicle lock 300, the reverse processes may be conducted.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A vehicle, comprising:
at least one wheel including an axle axis;
a vehicle lock including:
a lock support forming a part of the axle axis; and
a detachable handle that is spaced from and is detachable relative to the lock support.

2. The vehicle of claim 1, wherein the lock support includes a first engagement portion, and the detachable handle includes a second engagement portion that engages with the first engagement portion.

3. The vehicle of claim 1, wherein each of the first engagement portion and the second engagement portion is located at either side of the at least one wheel.

4. The vehicle of claim 1, wherein the lock support is pivotable about the axle axis.

5. The vehicle of claim 1, wherein one of the lock support and the detachable handle includes a lock element that locks the detachable handle to the lock support.

6. The vehicle of claim 1, wherein the lock support includes a first rod extending on one side of the wheel, a second rod extending on the other side of the wheel, and a connection connecting the first rod and the second rod.

7. A vehicle lock, comprising:
a lock support configured to form a part of an axle axis of a wheel; and
a detachable handle that is spaced from and is detachable relative to the lock support.

8. The vehicle lock of claim 7, wherein the lock support includes a first engagement portion, and the detachable handle includes a second engagement portion that engages with the first engagement portion.

9. The vehicle lock of claim 7, wherein each of the first engagement portion and the second engagement portion configured to be located at either side of the wheel.

10. The vehicle lock of claim 7, wherein the lock support is pivotable about the axle axis.

11. The vehicle lock of claim 7, wherein one of the lock support and the detachable handle includes a lock element that locks the detachable handle to the lock support.

12. The vehicle lock of claim 7, wherein the lock support includes a first rod extending on one side of the wheel, a second rod extending on the other side of the wheel, and a connection connecting the first rod and the second rod.

13. A method, comprising:
detaching a detachable handle of a vehicle lock from a lock support of the vehicle lock, wherein the lock support forms a part of an axle axis of a wheel; and
attaching the detachable handle to the lock support with a fixed structure being surrounded by the detachable handle and the lock support.
